(19) United States
(12) Patent Application Publication
(10) Pub. No.: US 2010/0303431 A1
(43) Pub. Date: Dec. 2, 2010

(54) Fiber Optic Harnesses and Assemblies Facilitating Use of a Pre-Connectorized Fiber Optic Cable(s) with a Fiber Optic Terminal

(76) Inventors: Terry D. Cox, Keller, TX (US); Diana Rodriguez, Fort Worth, TX (US)

Correspondence Address: CORNING INCORPORATED, INTELLECTUAL PROPERTY DEPARTMENT, SP-TI-3-1, CORNING, NY, 14831, US

(21) Appl. No.: 12/474,866

(22) Filed: May 29, 2009

(51) Int. Cl. G02B 6/00

(52) U.S. Cl. 385/135

(57) ABSTRACT

Fiber optic harnesses and fiber optic assemblies that can be used facilitate use of a pre-connectorized fiber optic cable(s) with a fiber optic terminal are disclosed. In one embodiment, the fiber optic terminal is provided and is comprised of a support member comprising one or more openings disposed through a first end of the support member. The support member may be configured to be separately attachable to a fiber optic terminal or may be integrated in an enclosure of a fiber optic terminal. At least one connector is disposed through the one or more openings of the support member. The at least one connector may be a hardened connector which may be suitable for use in outdoor environments. A fiber optic harness is provided and optically connected to the at least one connector on a first end and having at least one connector disposed on a second end.

### BACKGROUND

1. Field of the Disclosure

The technology of the disclosure relates to fiber optic harnesses and assemblies for fiber optic terminals. The fiber optic terminals include, but are not limited to, local convergence points (LCPs), fiber distribution terminals (FDTs) and the like.

2. Technical Background

To provide improved performance to subscribers, communication and data networks are increasingly employing optical fiber. The benefits of optical fiber are well known and include higher signal-to-noise ratios and increased bandwidth. To further improve performance, fiber optic networks are increasingly providing optical fiber connectivity all the way to end subscribers. These initiatives include various fiber-to-the-premises (FTTP), fiber-to-the-home (FTTH), and other fiber initiatives (generally described as FTTx).

In this regard, optical signals carried over fiber optic networks may be carried over fiber optic feeder cables to local convergence points (LCPs). The LCPs act as consolidation points for splicing, making cross-connections and interconnections, as well as providing locations for couplers and splitters. Fiber optic cables, such as distribution cables, exit the LCPs to carry optical signals between the fiber optic network and a subscriber's premises. Typical subscriber premises include single-dwelling units (SDUs), multi-dwelling units (MDUs), businesses, and/or other facilities or buildings. Fiber optic cables leaving the LCPs are typically run to one or more intermediate fiber distribution terminals (FDTs). FDTs facilitate FTTx applications by providing network access points to the fiber optic network to groupings of subscribers' premises. Optical interconnections to the subscribers' premises are typically provided via indoor/outdoor drop cables that are optically interconnected with the fiber optic cables within the FDTs. The FDTs also provide a consolidated location for technicians or other installation personnel to make and protect splices between the drop cables and the fiber optic cables as opposed to making splices in sporadic locations.

In either case of LCP and/or FDT fiber optic terminals, network-side fiber optic feeder cable stubs are fed into one or more openings in the fiber optic terminal enclosure during assembly. Optical fibers from the feeder cables are optically connected inside the fiber optic terminals during assembly and thus permanently attached during assembly. The feeder cable stubs are typically provided of customized lengths depending on the customer application. The fiber optic terminal with attached feeder cable stubs is then shipped to the customer. Providing fiber optic terminals with attached feeder cable stubs reduces flexibility. The fiber optic terminals must be shipped with the feeder cable stubs. The length of the feeder cable stubs are customized during assembly thereby increasing manufacturing complexity due to varying configurations for different applications and customers.

### SUMMARY

Embodiments disclosed include fiber optic harnesses and fiber optic assemblies. The fiber optic harness and fiber optic assemblies can facilitate use of a pre-connectorized fiber optic cable(s) with a fiber optic terminal. This advantageously allows feeder cable stubs or cables that can be supplied separately from a fiber optic terminal. In one embodiment, the fiber optic terminal is provided and comprised of a support member. The support member includes one or more openings disposed through a first end of the support member. The support member may be configured to be separately attachable to a fiber optic terminal or alternatively may be integrated into a fiber optic terminal. At least one connector is disposed through the one or more openings of the support member. The connector(s) disposed through the openings of the support member may be a hardened connector(s) suitable for use in outdoor environments or may be a connector(s) suitable for indoor use. A fiber optic harness is provided and optically connected to the connector(s) on a first end of the fiber optic harness. The fiber optic harness has at least one connector disposed on a second end optically connected to the connector(s) provided in the support member.

Additional features and advantages will be set forth in the detailed description which follows, and in part will be readily apparent to those skilled in the art from that description or recognized by practicing the embodiments described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is an exemplary fiber distribution terminal (FDT);

FIG. 2 is the exemplary FDT of FIG. 1 shown as being opened and without a skirt to show fiber optic connections made therein;

FIG. 3 illustrates an exemplary fiber optic assembly configured to be used with a fiber optic terminal;

FIG. 4 illustrates a perspective view of the fiber optic assembly of FIG. 3 with the enclosure cover removed;

FIG. 5 illustrates a perspective exploded view of the fiber optic assembly of FIG. 3;

FIGS. 6A and 6B illustrate front perspective views of the fiber optic adapters disposed through the openings of the enclosure of the fiber optic assembly of FIG. 3;

FIG. 7 illustrates an end of an exemplary fiber optic feeder cable that can be connected to the fiber optic adapters of the fiber optic assembly of FIG. 3;

FIGS. 8A and 8B illustrate a fully-connectorized fiber optic harness included in the fiber optic assembly of FIG. 3;

FIG. 9 illustrates the fiber optic assembly of FIG. 3 installed on an exemplary fiber optic terminal;

FIG. 10 illustrates the fiber optic terminal of FIG. 8 with the fiber optic assembly installed and a skirt lowered to illustrate the fiber optic cables disposed through the openings of the fiber optic terminal and connected to the fiber optic adapters;

FIG. 11 illustrates the fiber optic terminal of FIG. 10 with the skirt installed and enclosing the fiber optic terminal;

FIG. 12 illustrates a perspective view of an alternative fiber optic assembly configured for one fiber optic adapter and with the enclosure cover removed;

FIG. 13 illustrates the fiber optic assembly of FIG. 12 attached to a fiber optic terminal;

FIG. 14 illustrates a fiber optic terminal with a support member for a fiber optic assembly disposed through in base of the fiber optic terminal; and

FIG. 15 illustrates a fiber optic terminal with a fiber optic connector disposed through the support member in the fiber optic terminal of FIG. 15.

### DETAILED DESCRIPTION

Reference will now be made in detail to embodiments, examples of which are illustrated in the accompanying drawings, in which some, but not all embodiments are shown. Indeed, the concepts may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

Embodiments disclosed in the detailed description include fiber optic harnesses and fiber optic assemblies. The fiber optic harness and fiber optic assemblies can facilitate use of a pre-connectorized fiber optic cable(s) with a fiber optic terminal. Feeder cable stubs or cables can be supplied separately from a fiber optic terminal. In one embodiment, the fiber optic terminal is provided and comprised of a support member. The support member comprising one or more openings disposed through a first end of the support member. The support member may be configured to be separately attachable to a fiber optic terminal or may be integrated into a fiber optic terminal. At least one connector is disposed through the one or more openings of the support member. The connector(s) disposed through the openings of the support member may be a hardened connector(s) suitable for use in outdoor environments or may be a connector(s) suitable for indoor use. A fiber optic harness is provided and optically connected to the connector(s) on a first end of the fiber optic harness. The fiber optic harness has at least one connector disposed on a second end optically connected to the connector(s) provided in the support member.

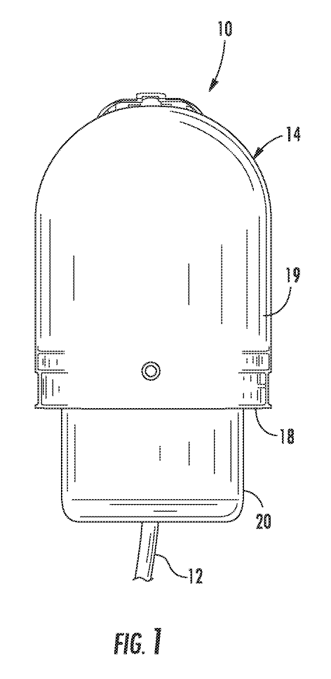

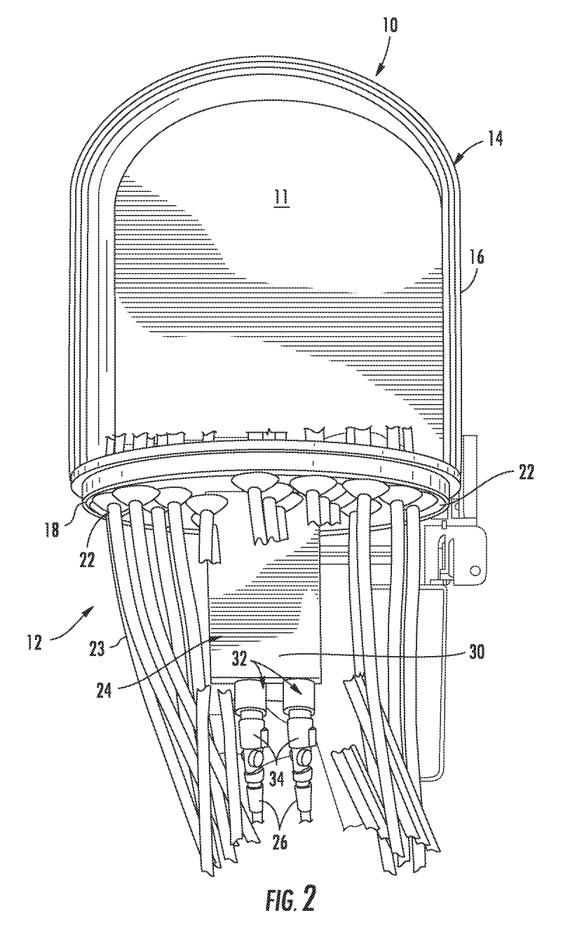

FIG. 1 illustrates an exemplary fiber optic terminal 10 that may employ fiber optic harnesses and fiber optic assemblies according to embodiments disclosed herein. The fiber optic terminal 10 provides a convenient access point in a telecommunications or data network for a field technician to install and reconfigure optical fiber connections between network-side and subscriber-side fiber optic cables. The fiber optic terminal 10 in FIG. 1 is the ClearCurve™ fiber distribution terminal (FDT) manufactured by Corning Cable Systems, LLC of Hickory, N.C., the assignee of the present application. However, the fiber optic terminal 10 but could be of any manufacturer or type, including but not limited to a local convergence point (LCP). One or more fiber optic cables 12 can be run or inserted inside the fiber optic terminal 10 to establish fiber optic connections inside an internal chamber 11 (FIG. 2) in the fiber optic terminal 10. Only one fiber optic cable 12 is illustrated in FIG. 1 as being run inside the fiber optic terminal 10. However, a plurality of fiber optic cables 12 may be run inside the fiber optic terminal 10. The fiber optic cables 12 can include both network-side and subscriber-side cables. The cables may be feeder or drop cables. By the term “subscriber-side,” it is meant that optical fiber, fiber optic cable, or optical connection, as the case may be, is provided anywhere between the end subscriber and the fiber optic terminal 10. By the term “network-side,” it is meant that the optical fiber, fiber optic cable, or optical connection, as the case may be, is provided between a fiber optic network, central switching point, central office, or the like and the fiber optic terminal 10.

As illustrated in FIGS. 1 and 2, the fiber optic terminal 10 includes an enclosure 14 formed by an open shell 16 (FIG. 2) having a base 18. A cover 19 can be affixed to the enclosure 14 to close off the open shell 16 and protect fiber optic components and connections established inside the enclosure 14. The shell 16 and cover 19 may be made of any suitable rigid material, such as aluminum, plastic, or thermoplastic. A skirt 20 may also be provided and attached to the enclosure 14 at the base 18 to group and protect fiber optic cables 12 running inside the enclosure 14 and to protect openings 22 in the base 18 in communication with the internal chamber 11 of the enclosure 14.

Drop cables 23 and feeder cables 26 can be connected to the fiber optic terminal 10 wherein connections (not shown) between optical fibers in the drop and feeder cables 23, 26 are optically connected inside the enclosure 14 of the fiber optic terminal 10. The drop cables 23 in this embodiment are not pre-connectorized. Instead, the cable jacket of the drop cables 23 are stripped and run inside the enclosure 14 during installation. The optical fibers of the drop cables 23 are terminated and then connected to fiber optic adapters (not shown) within the terminal to establish connections with the optical fibers of the feeder cables 26.

A fiber optic assembly 24 is provided as illustrated in FIG. 2 so that pre-connectorized feeder cables 26 (also referred to as “feeder cables 26”) can be connected to the fiber optic terminal 10 without having to make splices with optical fibers in the feeder cables 26. The fiber optic assembly 24 is attached to the base 18 of the fiber optic terminal 10 in this embodiment. Connections are made during assembly between the fiber optic assembly 24 and optical fibers of the drop cables 23 so that a pre-connectorized connection established with the fiber optic assembly 24 establishes a connection to the drop cables 23. As will be discussed in more detail below, the fiber optic assembly 24 includes a support member 30 comprising one or more openings 32 that support one or more hardened connectors 34 disposed externally from the support member 32 for access during installation. A support member is any device or configuration that supports one or more connectors to facilitate pre-connectorized connection between a fiber optic cable and the fiber optic terminal. The support member 30 illustrated in FIG. 2 is separate device constructed from a suitable material such as aluminum that is attached to the fiber optic terminal 10. A fiber optic harness 36 (FIG. 3) is optically connected to the hardened connectors 34 so that the pre-connectorized feeder cables 26 as illustrated in FIG. 2 can be connected to the fiber optic terminal 10 without requiring splicing. The support member 30 can be constructed out of a metal or other non-metal material, including but not limited to a polymer. Hardened connectors 34 are illustrated, but non-hardened connectors may be employed as well.

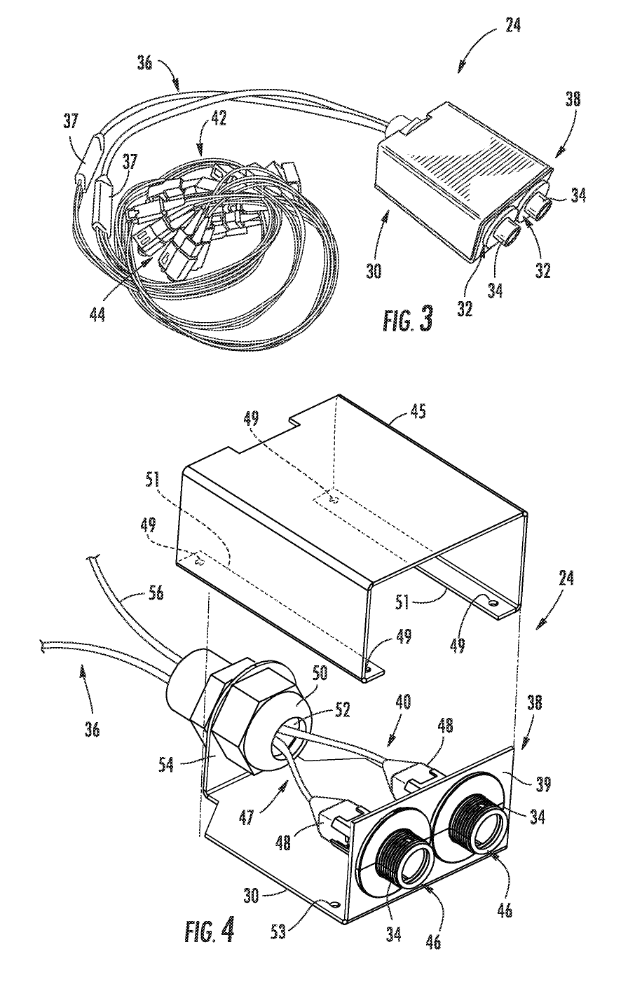

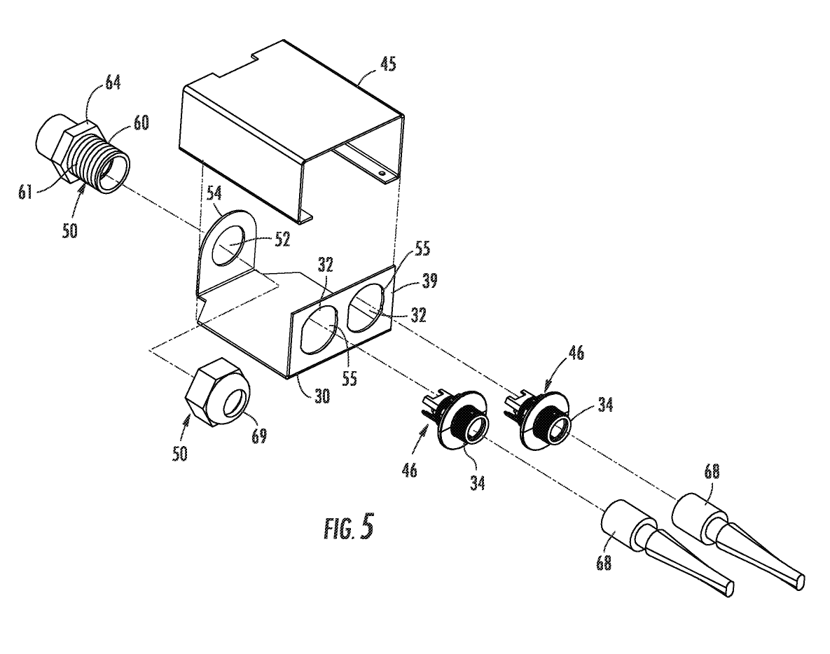

FIGS. 3-5 illustrate other views and detail on the components of the fiber optic assembly 24 in FIG. 2. As illustrated in FIG. 3, the fiber optic assembly 24 is shown. The fiber optic assembly 24 includes the support member 30. The support member 30 in this embodiment is a separate device configured to be separately attached to the fiber optic terminal 10 as illustrated in FIG. 2. However, the support member may be configured to be provided internally or as a part of the fiber optic terminal 10 and/or its enclosure 14 as will be described in alternative embodiments below. The support member 30 in this embodiment comprises two openings 32 disposed through a first end 38 of the support member 30. Of course, the support member may have any desired number of openings 32. Two hardened connectors 34 are disposed through the openings 32 of the support member 30 to allow pre-connectorized feeder cables 26 to be connected for establishing optical connectivity with the fiber optic harness 36 of the fiber optic assembly 24. As illustrated in FIG. 4, the fiber optic harness 36 is optically connected to the hardened connectors 34 on a first end 40 of the fiber optic harness 36. The fiber optic harness 36 has connectors 42 (FIG. 3) disposed on a second end 44 of the fiber optic harness 36. The connectors 42 on the second end 44 of the fiber optic harness 36 can be connected inside the enclosure 14 of the fiber optic terminal 10 to establish fiber optic connections with drop cables 23. In this manner, when the pre-connectorized feeder cables 26 (FIG. 2) are connected to the hardened connectors 34, the optical fibers in the pre-connectorized feeder cables 26 are connected to optical fibers in the fiber optic harness 36 and thus to the connectors 42.

In this embodiment, the fiber optic harness 36 consists of two twelve (12) fiber optic cables 56 for a total of twenty-four (24) fibers. However, any number of fiber optic cables 56 or fiber count may be provided. Fanout assemblies 37 are provided on the fiber optic cables 56 of the fiber optic harness 36 to break out the individual optical fibers from the fiber optic cables 56 to the connectors 42. Instead of having the fanout assembly, in other embodiments the fiber optic harness 36 may include one or more splitters 37 such as a 1×4, 1×8, 1×16, or 1×N splitter for providing multiple channels from a single fiber. The splitter 37 may be disposed along any suitable portion of the fiber optic harness 36 and may be located within the terminal 10, on the support member 30, or other suitable location. The fiber optic cables 56 may be of any fiber count and size, including but not limited to 900 micrometers (μm), and may or may including coating on the optical fibers contained therein. Also in this embodiment, the connectors 42 are simplex SC connectors, but may be a multi-fiber connector or connectors and any other type of connector or connectors, including but not limited to FC, LC, ST, MTP, and MPO connector types, etc. Further, the connectors 42 could be duplex connectors or other multi-fiber connectors.

FIG. 4 is a perspective view of the fiber optic assembly 24 with a cover 45 removed from the support member 30 to show the internal components of the fiber optic assembly 24 and the fiber optic harness 36 disposed therethrough and connected to the hardened connectors 34. The hardened connectors 34 are disposed through the openings 32 disposed in a first flange 39 of the support member 30. In this embodiment the hardened connectors 34 are provided as part of fiber optic adapters 46. However, the hardened connectors 34 may consist of other connector types, including but not limited to fiber optic plugs, fiber optic receptacle, or any combination thereof In this embodiment, the fiber optic harness 36 can be detached from the fiber optic adapters 46 and thus the hardened connectors 34. The fiber optic adapters 46 contain connection points on each side of the fiber optic adapter 46. The fiber optic adapters 46 in the fiber optic assembly 24 are MTP-to-Optitip™ adapters, wherein the hardened connector 34 is provided as an Optitip adapter on one side of the fiber optic adapter 46 and a MTP adapter is provided on the opposite side of the fiber optic adapter 46. The Optitip connectors are manufactured by Corning Cable Systems, LLC, and described in more detail in U.S. Pat. No. 7,264,402. However, note that any other suitable type of fiber optic adapter may be employed. For example, the fiber optic adapters 46 could be MTP-to-MTP fiber optic adapters if the fiber optic terminal 10 were employed indoors such that a hardened connector is not required. Additionally, other embodiments could have a receptacle to plug arrangement that does not require an adapter, but instead the receptacle or the plug is attached to the support member and is the hardened connector.

Detachable MTP connectors 48 are disposed on the first end 40 of the fiber optic harness 36 and are connected to the MTP-side of the fiber optic adapters 46 inside the support member 30. A plurality of end portions 47 of the first end 46 of the fiber optic harness 36 includes a plurality of optical fibers inserted through a conduit 50. The conduit 50 facilitates inserting the end portions 47 of the fiber optic harness 36 through a second opening 52 in a second flange 54 of the support member 30. The individual fiber optic cables 56 of the fiber optic harness 36 can be routed inside the fiber optic assembly 24 to establish fiber optic connections to feeder cables 26 connected to the hardened connectors 34. Once the fiber optic assembly 24 is assembled with a portion of the fiber optic harness 36 disposed through the second opening 52 and connected to the hardened connectors 34 (i.e., the fiber optic adapter 46 in this embodiment), the cover 45 can be placed on top of the support member 30 as illustrated in FIG. 3. The cover 45 secures and protects the first end 40 of the fiber optic harness 24 and the MTP-side of the fiber optic adapters 46.

In this embodiment, the cover 45 includes one or more orifices 49 disposed on lip sections 51 that are configured to align with orifices 53 disposed in the support member 30. Fasteners (not shown) can be used to secure the cover 45 to the support member 30, or other means can be employed including but not limited to snap connections and/or an adhesive. The fasteners may be loose or captive.

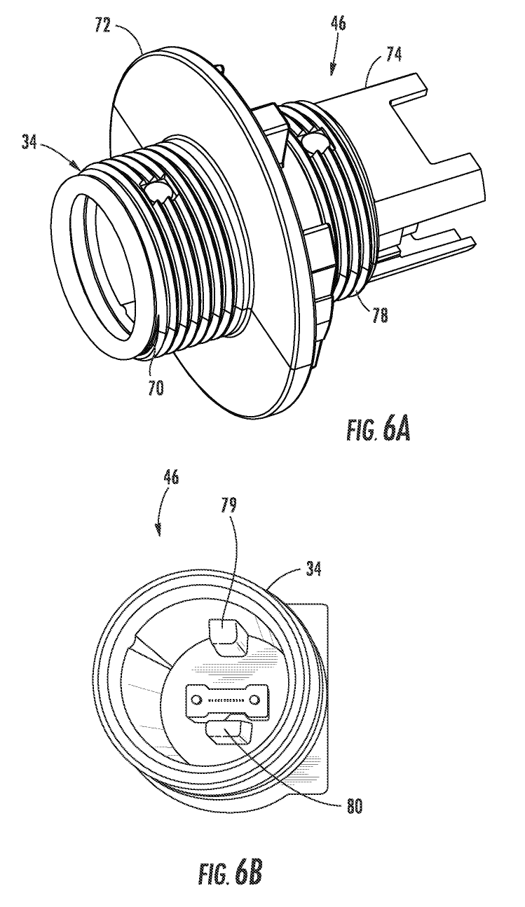

FIG. 5 illustrates a perspective exploded view of the fiber optic assembly 24 of FIG. 3 to illustrate the individual components of the fiber optic assembly 24. As illustrated therein, the fiber optic adapters 46 are configured to be inserted into the openings 32 disposed in the first flange 39 of the support member 30. The geometry of the inner diameter of the openings 32 may be shaped according to the geometry of an outer diameter of the fiber optic adapters 46 to provide for a secure fit of the fiber optic adapters 46 disposed through the openings 32. The fiber openings 32 could also be keyed 55 to receive a keyed structure disposed in the fiber optic adapters 46 if desired. The conduit 50 that is disposed through the second opening 52 of the support member 30 is comprised of a cylindrical member 60 having external threads 61 disposed through the second opening 52. To secure the member 60 in the second opening 52, the member 60 is inserted into the second opening 52 until a shoulder 64 reaches the second flange 54. An internally threaded nut 69 is screwed onto the external threads 61 of the member 60 to provide a compression fit of the shoulder 64 and the nut 69 on each side of the second flange 54 adjacent the second opening 52. Connectors 68, which may be disposed on the feeder cables 26 (FIG. 1), can be connected to the hardened connectors 34 as illustrated in FIG. 5.

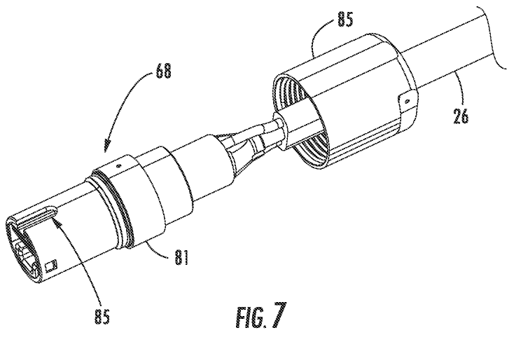

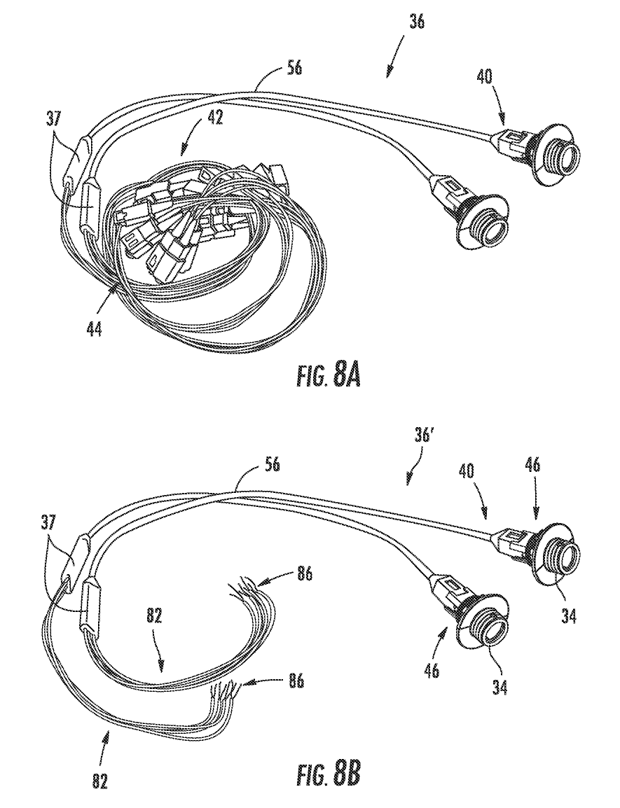

FIGS. 6A and 6B illustrate front perspective views of the fiber optic adapters 46 disposed through the openings 32 of the support member 30 of the fiber optic assembly 24 of FIG. 3. As illustrated therein, the hardened connector 34 contains external threads 70 for engaging with internal threads of the connectors 68 (FIG. 5) attached to the hardened connectors 34. A flange or shoulder 72 having an outer diameter greater than the inner diameter of the openings 32 is disposed in the fiber optic adapter 46 between the hardened connectors 34 and an MTP-side receptacle 74. In this manner, the hardened connectors 34 remain external to the support member 30 and cover 45 when disposed through the openings 32. The MTP-side receptacle 74 may also have external threads 78 to engage with internal threads inside the openings 32 (not shown) to secure the fiber optic adapter 46 inside the openings 32 of the fiber optic assembly 24. Alternatively, a locking nut, locking tab, or the like may be used for securing the fiber optic adapter 46 to the support member. FIG. 6B illustrates another view of the fiber optic adapter 46 wherein the internal components of the hardened connector 34 are illustrated (i.e., the ferrule of the connector is attached and visible). The hardened connector 34 may only receive a plug of like ferrule configuration. The hardened connector 34 defines a first key 79 that is received within a key slot 85 of a plug (see FIG. 7). As shown, the first key 79 is a protruding feature that is molded into the hardened connector 34. The hardened connector 34 further defines a second protruding feature 80 to prevent a dissimilar plug from being inserted into the hardened connector 34.

FIG. 7 illustrates an end of an exemplary feeder cable 26 that may be connected to the hardened connectors 34 of the fiber optic assembly 24 of FIG. 3. As illustrated, connector 68 is a plug 81 such as the Optitip™ plug depicted. A threaded coupling nut 85 on the plug 81 is operable for securing the plug 81 to the hardened connector 34 upon engagement. The plug 81 contains a key slot 85 that is aligned with the first key 79 of the hardened connector 34 as illustrated in FIG. 6B.

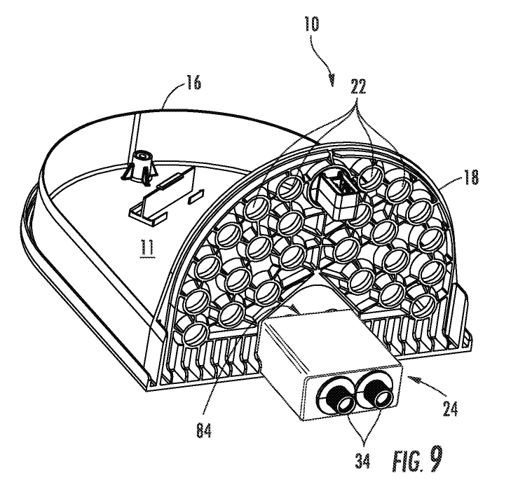

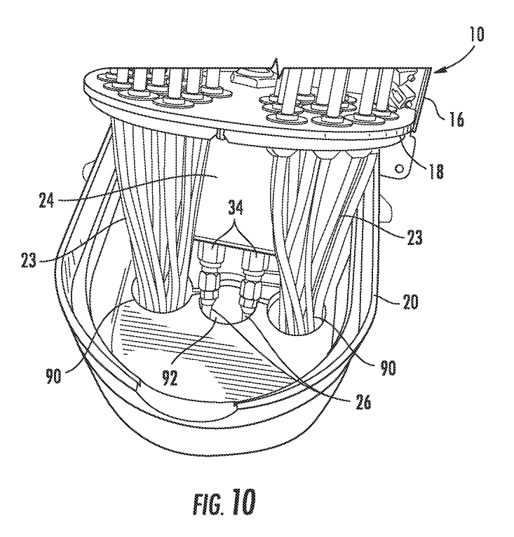

FIGS. 8A and 8B illustrate variations of the fiber optic harness 36 that can be employed in the fiber optic assembly 24 of FIG. 3. The fiber optic harness 36 in FIG. 8A is the fiber optic harness 36 employed in the fiber optic assembly 24 as illustrated in FIG. 3 and thus will not be discussed further. FIG. 8B illustrates an alternative fiber optic harness 36′ that can be employed in the fiber optic assembly 24 of FIG. 3. In the fiber optic harness 36′ of FIG. 8B, instead of the connectors being disposed on the second end 44 of the fiber optic harness 36′, the optical fibers 86 of the cable harnesss 36′ are not connectorized. The fiber optic cables 56 are provided with pigtails 82 so that the optical fibers 86 can be connected via single fiber or multi-fiber splices inside the fiber optic terminals 10.

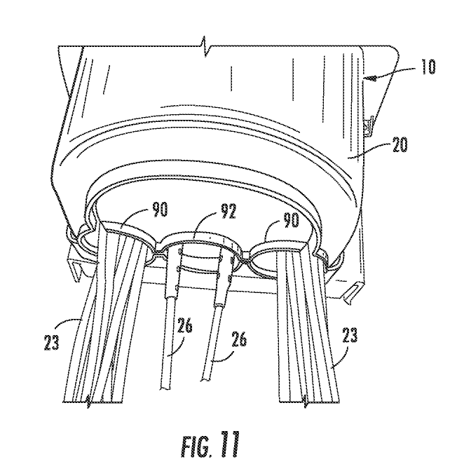

FIG. 9 illustrates the fiber optic assembly 24 of FIG. 3 installed on the fiber optic terminal 10. As illustrated, the fiber optic assembly 24 is installed on the base 18 of the fiber optic terminal 10. The fiber optic assembly 24 is fit into a feeder cable opening 84 in the base 18 where feeder cables 26 would normally be disposed if the fiber optic assembly 24 were not employed. The fiber optic assembly 24 is compression fit to the base 18 via the conduit 50 previously discussed and illustrated in FIG. 5. The cables 56 of the fiber optic harness 36 (not shown) are disposed inside the internal chamber 11 of the fiber optic terminal 10 to establish connections. Thus, the feeder cables 26 can be connected to the hardened connectors 34 when the fiber optic terminal 10 is installed so that connections are established with pre-connectorized feeder cables 26.

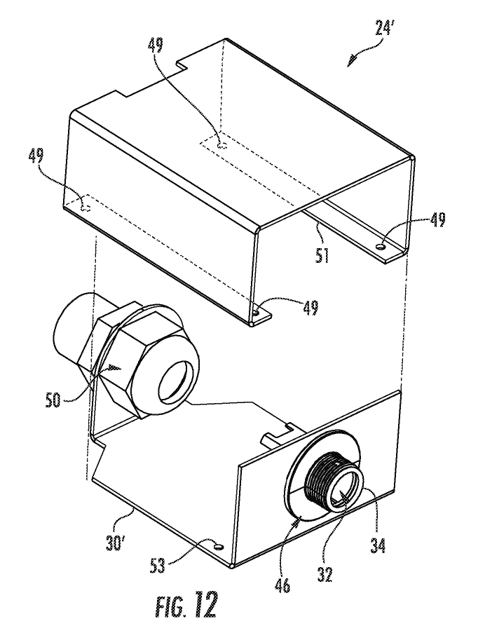

After the fiber optic assembly 24 is connected to the fiber optic terminal 10, the skirt 20 can be raised up as illustrated in FIG. 10 to prepare for securing to the fiber optic terminal 10 as illustrated in FIG. 11. The skirt 20 may comprised one or more openings 90, 92 for allowing drop and feeder cables 23, 36 to extend therethrough and from the fiber optic terminal 10.

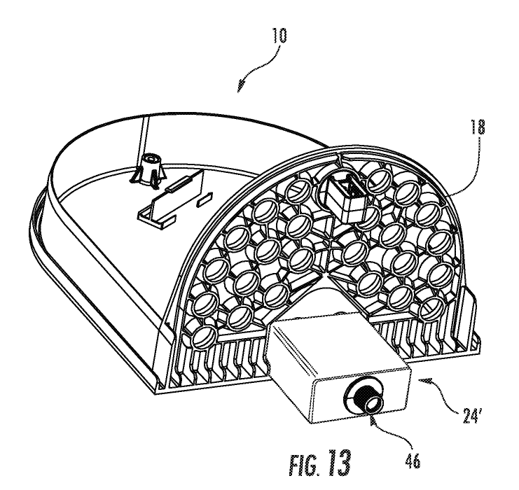

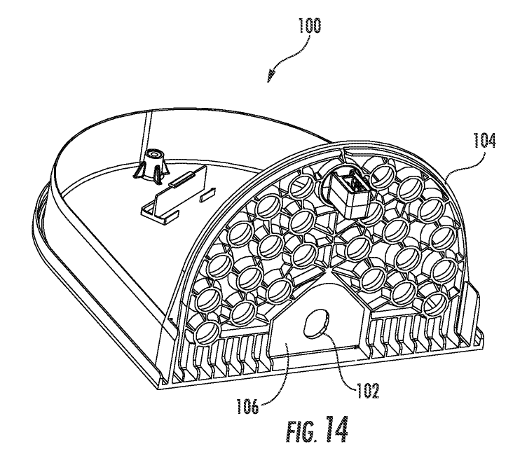

FIGS. 12 and 13 illustrate another embodiment of a fiber optic assembly 24′. The fiber optic assembly 24′ contains essentially the same components as provided in the fiber optic assembly 24 of FIG. 3. However, in the fiber optic assembly 24′ of FIG. 12, only one opening 32 is disposed in the support member 30′ to support one feeder cable. As a result, only one fiber optic adapter 46 is provided in the fiber optic assembly 24′. The fiber optic adapter 46 is a MTP-to-Optitip adapter with a hardened connector 34 in this embodiment, but any type of adapter arrangement is possible, including but hardened and non-hardened or indoor connectors. The fiber optic assembly 24′ of FIG. 12 is shown in FIG. 13 as being installed on the base of the fiber optic terminal 10 similar to the fiber optic assembly 24 of FIG. 9.

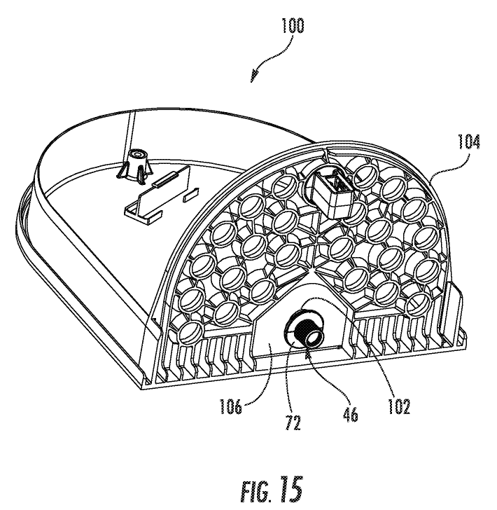

FIGS. 14 and 15 illustrate another embodiment of a fiber optic assembly wherein the support member is integrated into a fiber optic terminal 100. In this embodiment as illustrated in FIG. 14, an opening 102 provided as part of the base 104 of the fiber optic terminal 10 and configured to receive the fiber optic adapter 46. A fiber optic adapter just like the fiber optic adapter 46 in FIGS. 6A and 6B can be disposed in the opening 102 just as provided for the fiber optic assemblies 24, 24′ discussed above. More than opening 102 could be provided. FIG. 15 illustrates the fiber optic adapter 46 disposed through the opening 102 and ready to receive a pre-connectorized feeder cable. The base 104 contains a support surface 106 that contains the opening 102 to provide for a pre-connectorized connection to a pre-connectorized feeder cable. The flange 72 of the fiber optic adapter 46 abuts the support surface 106 when the fiber optic adapter 46 is disposed through the opening 102. In this manner, a separately attachable support member is not required. The opening 102 can be of the same geometry as the openings 32 in the support member 30 of the fiber optic assemblies 24, 24′ discussed above. In this manner, a pre-connectorized feeder cable can be connected to the fiber optic adapter to establish a fiber optic connection with optical fibers disposed inside the fiber optic terminal 100.

Many modifications and other embodiments set forth herein will come to mind to one skilled in the art to which the embodiments disclosed herein pertain having the benefit of the teachings presented in the foregoing descriptions and the associated drawings. These modifications include, but are not limited to a fiber optic assembly support member as either a separate or integrated device to a fiber optic terminal, type of connectors, which may be hardened or not hardened and/or outdoor and indoor, connector type, including but not limited to SC, FC, LC, ST, MTP, and MPO, etc. Any fiber count of the fiber optic harness may be provided. The fiber optic harness may be detachable or not from the fiber optic connector disposed through the openings of the fiber optic assembly. The fiber optic assemblies and harnesses may be employed with any type of fiber optic terminal.

Further, as used herein, it is intended that terms “fiber optic cables” and/or “optical fibers” include all types of single mode and multi-mode light waveguides, including one or more bare optical fibers, loose-tube optical fibers, tight-buffered optical fibers, ribbonized optical fibers, bend-insensitive optical fibers, or any other expedient of a medium for transmitting light signals. Therefore, it is to be understood that the disclosure is not to be limited to the specific embodiments disclosed and that modifications and other embodiments are intended to be included within the scope of the appended claims. It is intended that the disclosure cover the modifications and variations of the embodiments provided they come within the scope of the appended claims and their equivalents. Although specific terms are employed herein, they are used in a generic and descriptive sense only and not for purposes of limitation.

What is claimed is:

1. A fiber optic assembly, comprising:
a support member comprising one or more openings disposed through a first end;
at least one hardened connector disposed through the one or more openings of the support member; and
a fiber optic harness optically connected to the at least one hardened connector on a first end and having at least one connector disposed on a second end.

2. The fiber optic assembly of claim 1, wherein the support member is configured to be separately attached to a fiber optic terminal.

3. The fiber optic assembly of claim 1, wherein the support member is integrated in an enclosure of a fiber optic terminal.

4. The fiber optic assembly of claim 1, wherein the at least one hardened connector is comprised from the group consisting of at least one fiber optic adapter, at least one fiber optic plug, and at least one fiber optic receptacle.

5. The fiber optic assembly of claim 1, wherein the at least one hardened connector is disposed on the first end of the fiber optic harness.

6. The fiber optic assembly of claim 1, wherein the second end of the fiber optic harness is inserted through a second opening of the support member.

7. The fiber optic assembly of claim 6, wherein a plurality of end portions of the second end of the fiber optic harness includes a plurality of optical fibers inserted through the second opening of the support member.

8. The fiber optic assembly of claim 7, further comprising a fanout assembly disposed in the plurality of optical fibers between the first end and the second end of the fiber optic harness.

9. The fiber optic assembly of claim 1, wherein the one or more openings are keyed to support the at least one hardened connector.

10. The fiber optic assembly of claim 6, further comprising a conduit disposed through the second opening of the support member and receiving the fiber optic harness.

11. The fiber optic assembly of claim 1, wherein the support member further comprises a first flange disposed on the first end of the support member, wherein the one or more openings are disposed through the first flange.

12. The fiber optic assembly of claim 6, wherein the support member further comprises a second flange disposed on the second end, wherein the second opening is disposed through the second flange.

13. The fiber optic assembly of claim 1, further comprising a cover secured to the support member to form an enclosure.

14. The fiber optic assembly of claim 1, wherein the fiber optic harness further includes at least one splitter.

15. A fiber optic assembly, comprising:
a support member, comprising:
a base comprising one or more openings disposed through a first flange on a first end and a second opening disposed through a second flange on a second end opposite the first end; and
a cover attached to the base to form an enclosure;
at least one fiber optic connector disposed through the one or more openings in the base of the support member; and
a fiber optic harness optically connected to the at least one fiber optic connector on a first end and having at least one connector disposed on a second end.

16. The fiber optic assembly of claim 15, wherein the at least one fiber optic connector is disposed on the first end of the fiber optic harness.

17. The fiber optic assembly of claim 15, wherein the second end of the fiber optic harness is inserted through the second opening of the support member.

18. The fiber optic assembly of claim 15, wherein the fiber optic harness further includes at least one splitter.

19. A fiber optic harness, comprising:
a fiber optic cable including one or more optical fibers and having a first end and a second end;
one or more outdoor hardened connectors disposed on the first end of the fiber optic cable and optically connected to the one or more optical fibers; and
a plurality of fiber optic connectors disposed on the second end of the fiber optic cable and optically connected to the one or more optical fibers.

20. The fiber optic harness of claim 19, wherein the one or more outdoor hardened connectors are comprised from the group consisting of at least one fiber optic adapter, at least one fiber optic plug, and at least one fiber optic receptacle.

21. The fiber optic harness of claim 19, further comprising a fanout assembly disposed in the one or more optical fibers between the first end and the second end of the fiber optic cable.

22. The fiber optic harness of claim 19, wherein the plurality of fiber optic connectors includes at least one connector of a type including SC, FC, LC, ST, MTP, and MPO.

23. The fiber optic harness of claim 19, further including at least one splitter.
